(19) United States
(12) Patent Application Publication
(10) Pub. No.: US 2014/0040349 A1
(43) Pub. Date: Feb. 6, 2014

(54) SERVER COMPUTER, SERVER COMPUTER SYSTEM, AND SERVER COMPUTER CONTROL METHOD

(71) Applicants: Hiroya Matsuba, Tokyo (JP); Toshiyuki Ukai, Tokyo (JP); Takashi Yasui, Tokyo (JP)

(72) Inventors: Hiroya Matsuba, Tokyo (JP); Toshiyuki Ukai, Tokyo (JP); Takashi Yasui, Tokyo (JP)

(73) Assignee: HITACHI, LTD., Tokyo (JP)

(21) Appl. No.: 14/003,115

(22) PCT Filed: Sep. 14, 2011
(86) PCT No.: PCT/JP2011/005154

§ 371 Date: Sep. 27, 2013

(51) Int. Cl. H04L 29/08

(52) U.S. Cl. CPC H04L 67/1097
USPC 709/203

(57) ABSTRACT

A server computer, upon receiving a signal for a write request to a storage device from a management computer, performs a provisional write, which is a write related to the write request signal, to a first storage part in the server computer, and sends a first notification signal indicating that the provisional write has been completed to the management computer. The management computer, upon receiving the first notification signal, transmits a second notification signal indicating that the management computer has received the first notification signal to the server computer. The server computer, upon receiving the second notification signal, performs write processing to the storage device. Thereby, a failure caused by dual execution of write processing to the disk is prevented when transferring processing from a main server to an auxiliary server in a case where the main server fails with regard to processing accompanying writing to the disk.

### BACKGROUND

The invention relates to control of a server computer and, in particular, relates to a method of controlling writing to a disk device by the server computer.

In many of the cases where massive data processing by computer is demanded, the data is distributed to a plurality of computers to be simultaneously processed in parallel. In some of the cases where a series of complex steps are required to complete processing, independent computers dedicated to different steps are prepared to perform the processing while transferring results of the individual steps among them. In such data processing utilizing a plurality of computers, it is common, for the purpose of convenience in giving and receiving data, to construct a shared file system that contains files to be processed or to retain results of processing on the network, so that all computers can access the same file.

A shared file system is easy to become a single point of failure because of the nature that the shared file system provides files to all over the system. That is to say, if the computer providing the shard file system goes down, file accesses will be unavailable in the entire system to cause a catastrophic system halt. For this reason, a shared file system created for a large-scale system is configured with multiple computers to provide a failover function that enables uninterrupted file accesses when a failure occurs in a computer.

Lustre 2.0 Operations Manual, Chapter 30, [online] Internet, accessed Sep. 2, 2011, discloses a method as follows. When a computer (hereinafter, client) for making a request to create or write to a file issues a request involving writing to a computer for processing the request (hereinafter, server), the server assigns a unique transaction number to the processing.

The server writes the requested matter and the latest transaction number to a disk. The client is notified of the transaction number and keeps the details of the request and the transaction number until the writing to the disk by the server is confirmed. If a failure occurs in the server, a substitute computer is activated to check the contents of the disk used by the previous server. Since the disk has a record of transaction numbers of the completed writing to the disk, the substitute computer checks the numbers and requests the client to re-execute the processing that has not written the disk yet.

### CITATION LIST

Non-Patent Literature 1: Lustre 2.0 Operations Manual, Chapter 30, [online] Internet [accessed Sep. 2, 2011]

### SUMMARY

The existing technique as disclosed in the aforementioned Lustre 2.0 Operations Manual assigns a transaction number to a request from the client and writes the transaction number to the disk together with the requested matter, so that the client's request can be restored without duplication or lack in the case of failure in the server. Such an example is illustrated in FIG. 16. The file system client requests the server to create a file A with a message M1601 under a transaction number 1. The server requests the disk to create the file A with a message M1602 and requests the disk to write information indicating the latest transaction number is 1. Then, the server returns a success of the processing to the client with a message M1604. If a failure occurs in the server, the substitute server acquires the latest transaction number (0 in this example because the writing under the transaction number 1 is failed) and notifies the client of the latest transaction number with a message M1605 for re-execution of the failed processing. The client re-executes the processing starting from the failed latest request 1 (message M1606). If writing the transaction number is inseparable from writing the contents of the processing, it will not cause any problem; however, if creating the file is successful but writing the transaction number is failed as shown in the example of FIG. 16, the re-execution with a message M1607 urges double execution to cause an error which does not occur normally. To eliminate such a problem, a function is required, for example, that writes the transaction number to the disk file system inseparably from writing the contents of the processing.

However, incorporating a new function to the standard disk file system included in an operating system is more likely difficult in view of the possibility of acquisition of source codes or compatibility with the existing files. However, incorporating a new function to the standard disk file system included in an operating system is more likely difficult in view of the possibility of acquisition of source codes or compatibility with the existing files. In order to eliminate this difficulty, it is required to develop an entire disk file system, which increases the cost for development and maintenance of software.

The invention is accomplished in view of the foregoing problems; an object of the invention is, when an auxiliary server takes over processing from a failed main server, to prevent an error caused by double execution of writing without providing a special function of the disk file system, such as a function for recording transaction numbers.

A representative example of the invention disclosed in this application is as follows. Upon receipt of a request signal for writing to a storage device from a management computer, at least one server computer performs provisional writing, which is writing related to the information processing request, to a first storage part included in the at least one server computer and sends a first notification signal indicating completion of the provisional writing to the management computer. Upon receipt of the first notification signal, the management computer sends a second notification signal indicating that the management computer has received the first notification signal to the at least one server computer. Upon receipt of the second notification signal, the at least one server computer performs writing to the storage device.

The invention prevents an error caused by double execution of writing without providing a special function in the disk file system, such as a function for recording transaction numbers, when an auxiliary server takes over processing from a failed main server.

### BRIEF DESCRIPTION OF THE DRAWINGS

FIG. 1 is a block diagram illustrating a configuration of a computer system in Embodiment 1 of the invention;

FIG. 2 is a sequence diagram of a procedure of file input/output in Embodiment 1 of the invention;

FIG. 3 is a sequence diagram of a procedure of the processing when a failure occurs in the server computer after data is written to the disk device in Embodiment 1 of the invention;

FIG. 4 is a sequence diagram of a procedure of the processing when a failure occurs in the server computer before data is written to the disk device in Embodiment 1 of the invention;

FIG. 5 is a sequence diagram of a procedure of the processing when a failure occurs in the server computer before the client computer receives a processing result in Embodiment 1 of the invention and a flowchart of a procedure of setting the rules;

FIG. 6 is a flowchart of a procedure of processing of a user request transfer module in Embodiment 1 of the invention;

FIG. 7 is a flowchart of a first part of processing of a user request provisional execution module in Embodiment 1 of the invention;

FIG. 8 is a flowchart of a second part of processing of the user request provisional execution module in Embodiment 1 of the invention;

FIG. 9 is a flowchart of processing of an ACK processing module in Embodiment 1 of the invention;

FIG. 10 is a flowchart of processing of a resend processing module in Embodiment 1 of the invention;

FIG. 11 is an explanatory diagram of an example of request history information in Embodiment 1 of the invention;

FIG. 12 is an explanatory diagram of an example of memory file system information in Embodiment 1 of the invention;

FIG. 13 is a flowchart of processing of a failover processing module in Embodiment 1 of the invention;

FIG. 14 illustrates a parallel file system in Embodiment 2 of the invention;

FIG. 15 is a flowchart of processing of a parallel file system client module in Embodiment 2 of the invention; and

FIG. 16 is an example of a sequence of failover processing in a computer system which does not employ the invention.

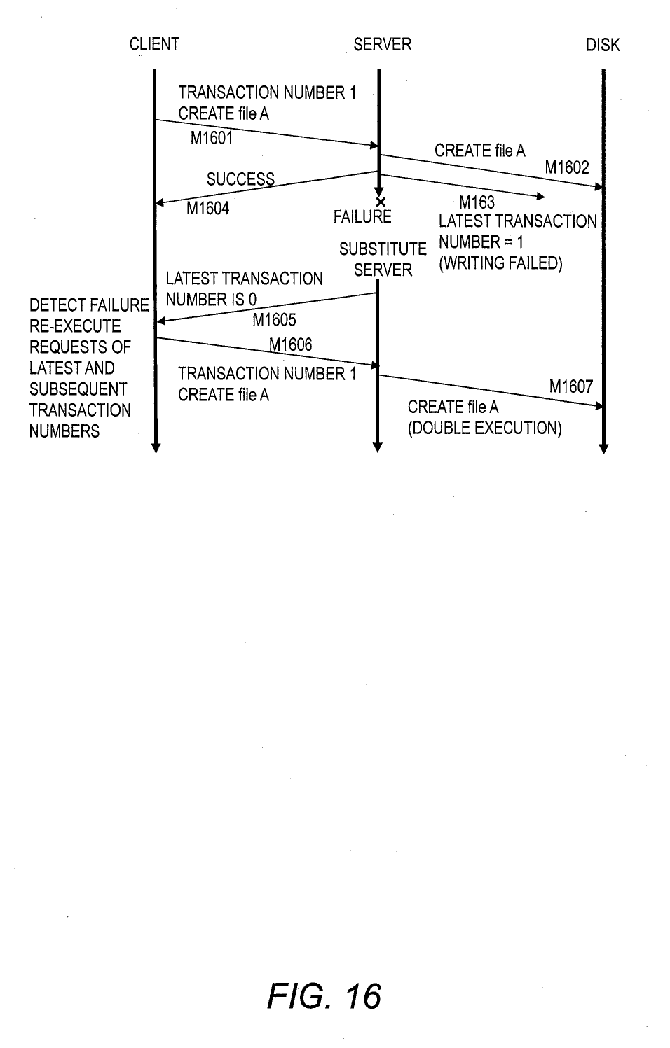

### DETAILED DESCRIPTION OF THE EMBODIMENTS

Hereinafter, embodiments of the invention will be described in detail with drawings.

### Embodiment 1

This embodiment first provides an example of device configuration to embody the invention, thereafter, outlines overall processing, and then explains the details.

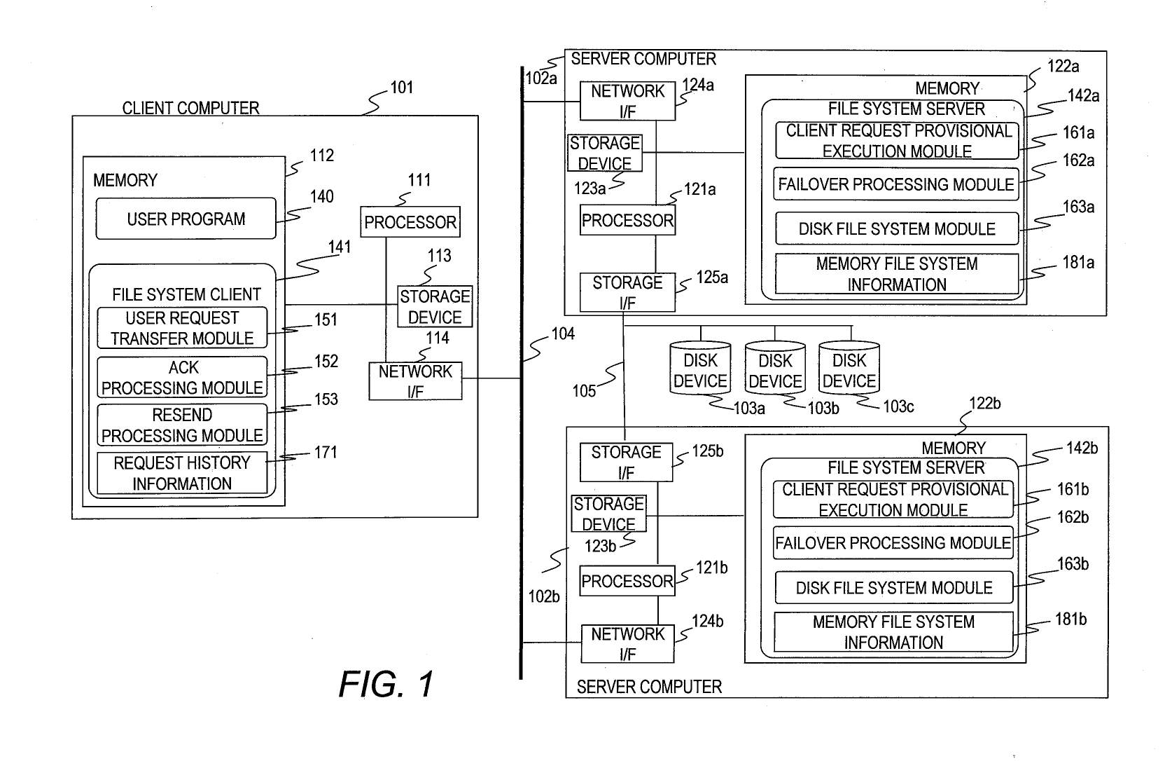

First, a configuration of a computer system in Embodiment 1 is explained with a block configuration diagram shown in FIG. 1. A client computer 101 is connected to server computers 102a and 102b via a network 104. To the server computers 102a and 102b, disk devices 103a to 103c are connected. Both of the server computers 102a and 102b are connected so as to be accessible to the same disk devices 103a to 103b via a network 105.

The network 104 is, for example, a LAN (Local Area Network). The network 105 is, for example, a SAN (Storage Area Network).

The client computer 101 is a computer apparatus to be used by a system administrator or a user, including a processor 111, a memory 112, a storage device 113, and a network interface 114, and connected to the network 104 via the network interface 114. The memory 112 of the client computer 101 holds a user program 140 and a file system client 141; for example, the user program 140 issues a data input/output command to the file system client 141. The user program 140 and the file system client 141 are computer programs; they are loaded to the memory 112 from the storage device 113 or from a different computer via the network 104 using the network interface 114 and executed by the processor 111. The file system client 141 includes a user request transfer module 151, an ACK processing module 152, a resend processing module 153, and a request history information 171, which will be described later.

The server computer 102a is a computer apparatus for receiving file input/output requests from the client computer 101 and accessing the disk devices 103a to 103c, and includes a processor 121a, a memory 122a, a storage device 123a, a network interface 124a, and a storage interface 125a. The server computer 102a is connected to the network 104 via the network interface 124a and connected to the network 105 via the storage interface 125a.

The memory of the server computer 102a holds a file system server 142a to process requests from the file system client 141. The file system server 142a is a computer program, which is loaded to the memory 122a from the storage device 123a or from a different computer via the network 104 using the network interface 124a and is executed by the processor 121a. The file system server 142a includes a client request provisional execution module 161a, a failover processing module 162a, a disk file system module 163a, and memory file system information 181a, which will be described later.

The server computer 102b is a computer apparatus having the same configuration as that of the server computer 102a including the aforementioned file system server 142a, processor 121a, storage device 123a, and the like, and is connected to the network 104 via a network interface and connected to the network 105 via a storage interface. The memory 122b of the server computer 102b holds a client request provisional execution module 161b having the same configuration and function as the client request provisional execution module 161a, a failover processing module 162b having the same configuration and function as the failover processing module 162a, a disk file system module 163b having the same configuration and function as the disk file system module 163a, and memory file system information 181b having the same configuration and function as the memory file system information 181a, and they are executed by the processor 121b.

This embodiment is described assuming that the server computer 102a is a server computer to be used normally and the server computer 102b is a substitute server computer to be used when a failure occurs in the server computer 102a; however, the roles of the server computers 102a and 102b may be exchanged because they have no difference in configuration and function. Alternatively, both of them may be configured to be a substitute server of the other.

The disk devices 103a to 103c are storage devices connectable to the network 105; they may be hard disk drives (HDDs), semiconductor disks (SSDs), or a storage array in which HDDs and SSDs are combined as a RAID system.

Next, an overview of the functional blocks in the file system client 141 is provided.

The user request transfer module 151 transfers file input/output commands from the user program to the server computer. The ACK processing module 152 manages whether a processing request sent by the user request transfer module 151 has been successfully processed or not. The resend processing module 153 requests the server computer 102b working as a substitute server after occurrence of a failure in the server computer 102a to re-execute the request which was received by the server computer 102a before the failure but has not been completely processed. The request history information 171 is management information for the ACK processing module 152 to manage uncompleted processing.

Next, an overview of the file system server 142a is provided.

The client request provisional execution module 161a receives a request from the file system client 141 and performs processing on the memory file system information 181a. The failover processing module 162a receives a request from the resend processing module 153 of the file system client. The disk file system module 163a manages the data structure of data stored in the disk devices 103a to 103c and provides a variety of processing such as reading a file and writing a file. The disk file system module 163a converts a manipulation request to create, delete, read, or write to a file into a read/write request designating a recording position in the disk device 103a or other disk device and written in a recording format in the disk devices and issues the read/write request to the disk. The memory file system information 181a is a data structure for the client request provisional execution module 161a to execute a processing request from the file system client on the memory on a temporary basis.

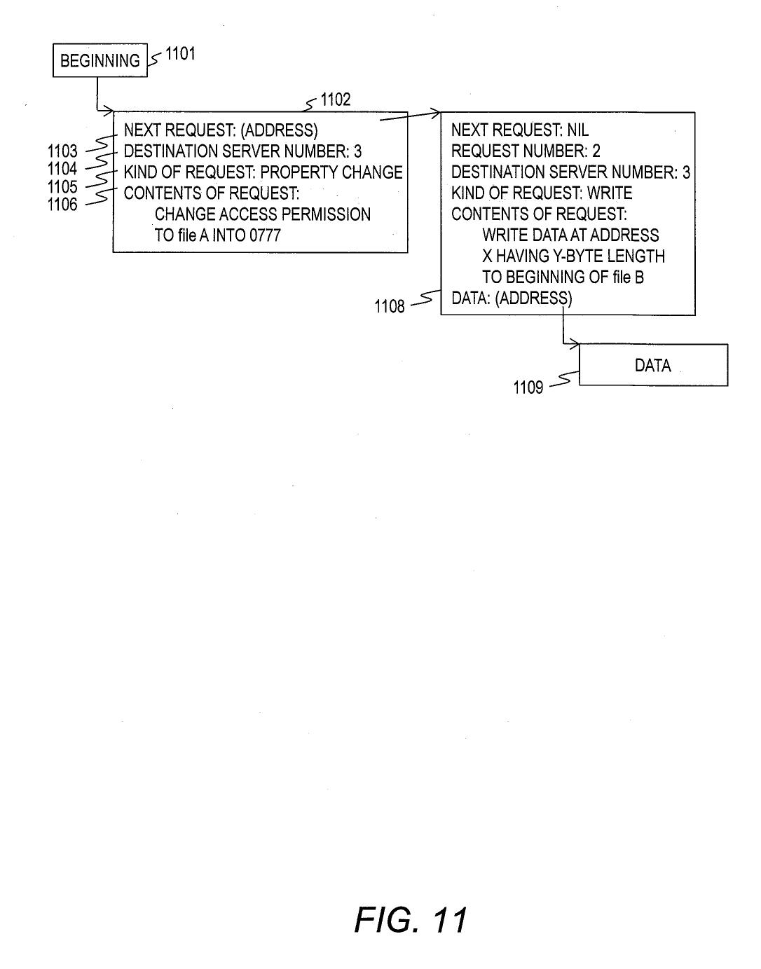

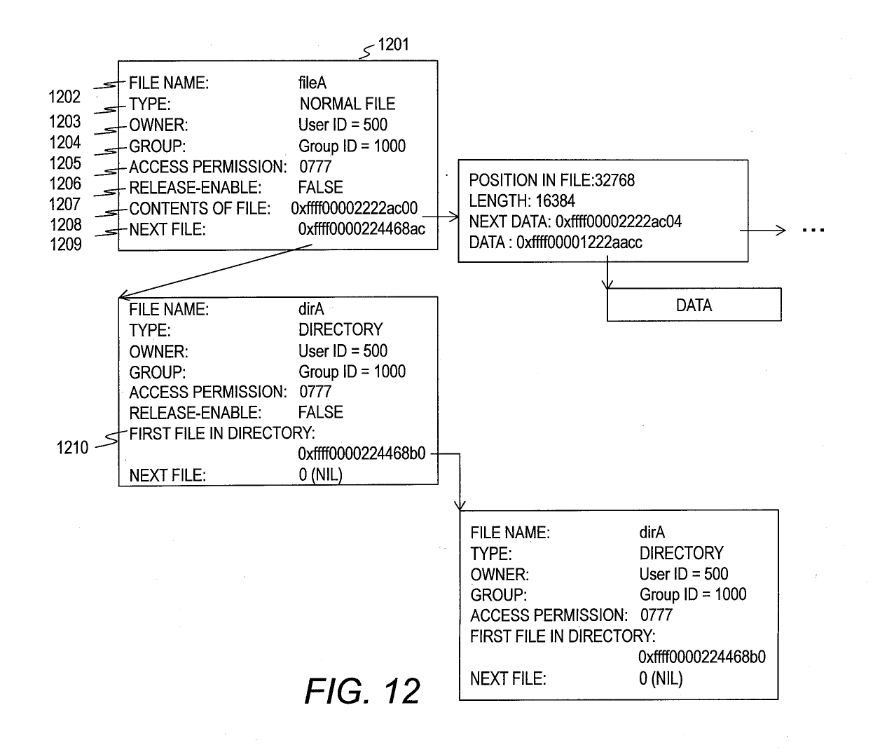

Next, with FIGS. 11 and 12, configuration examples of the request history information 171 and the memory file system information 181a are described in detail, which are data structures created in the storage devices described in the explanation on FIG. 1. However, the followings are examples of data structures and any format can be employed if the equivalent information can be retained.

FIG. 11 illustrates a configuration example of the request history information 171. The request history information has a list structure in which each request is an element. This description does not provide details of a specific method to create a list structure on a memory of a computer. The list starts linking from a structure 1101 representing the beginning; each element of the list includes a pointer to the next request 1103, the identification number of destination server computer 1104, the kind of request 1105, and the contents of request 1106. The kind of request is a value representing the kind of the manipulation among various file manipulations, such as file creation, file write, property change, and the like. The identification number of destination server computer is a number for identifying the file server computer to which the request is sent and may be a node number agreed between the file system server and the client or a network address. The contents of request depend on the kind; for example, in the case of file creation, the contents of request include data to identify the parent directory, a file name, and property information at creation time. In the case of data write, the contents of request include a memory address 1108 holding written data and the data itself 1109. The contents of request can be held in any way but the simplest way is to hold all information sent to the network at the execution of the request.

FIG. 12 illustrates a configuration example of the memory file system information 181a. The example of memory file system information in FIG. 12 has a tree structure in which the retained directories are regarded as nodes. This description does not provide details of the method to create a tree structure on a memory of a computer. Since each directory retains files included in the directory in the list structure, it holds a memory address 1210 where the memory holds the information on the first file. Each directory holds the name of directory and property such as access permission. Each file has a name 1202 and the type of file (the property 1203, the owner 1204, the group 1205, the access permission 1206, and the release-enable flag 1207), in addition, the memory address 1208 retaining the data recording the contents of the file and the pointer 1209 to the information on the next file in the same directory.

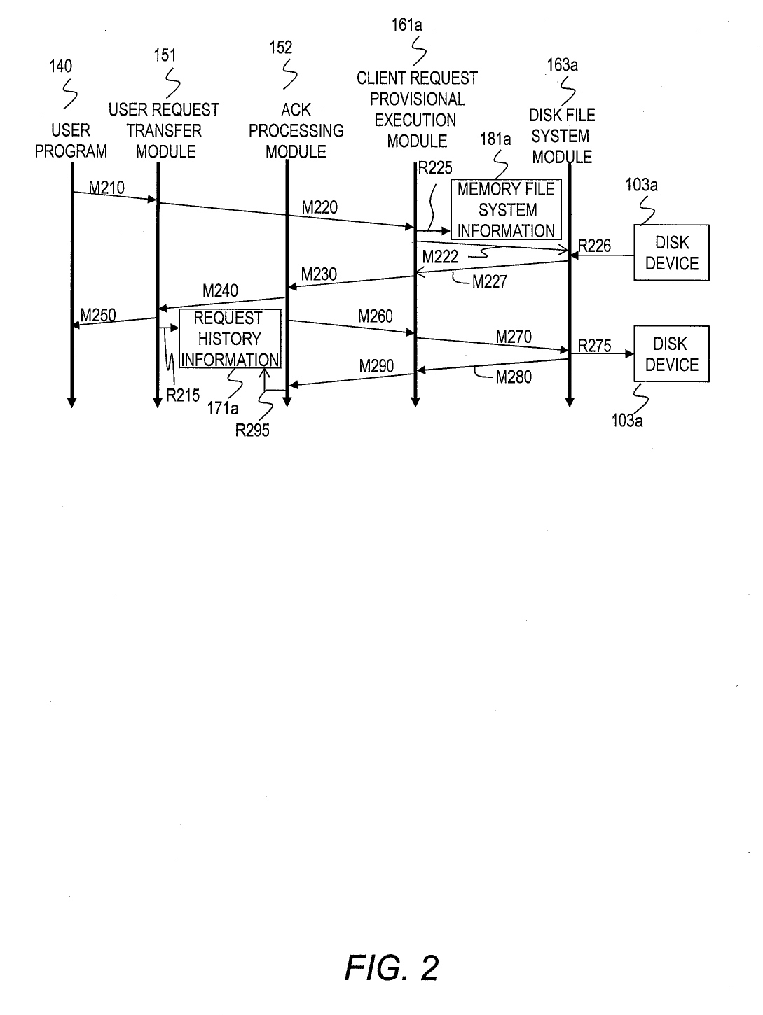

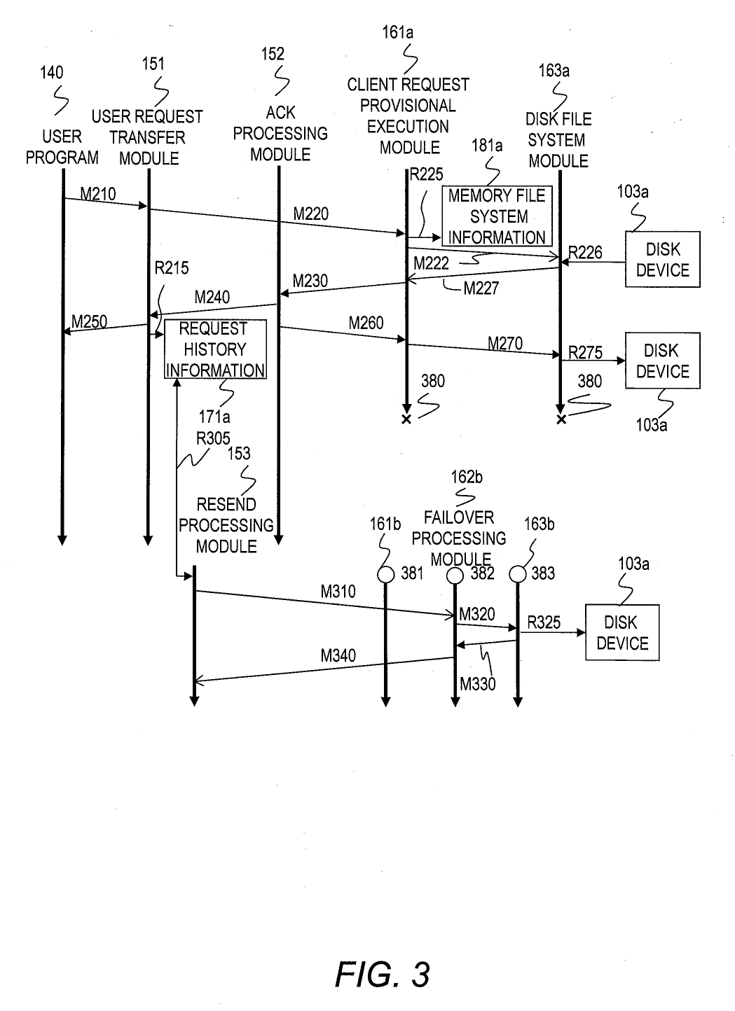

Described above is a configuration example of a computer system in this embodiment; hereinafter, operations of the components shown in FIG. 1 and relations between the components are described in detail. In this embodiment, FIG. 2 illustrates an outline of operations in the case of no failure in the server computer 102a. FIGS. 3, 4, and 5 illustrates outlines of operations in the cases where a failure occurs in the server computer 102a. To explain that the method of the invention can cope with a failure that occurs in the server computer 102a at any time in FIG. 2, this embodiment provides three separate cases depending on the time of occurrence of a failure in the server computer 102a (denoted by cross marks 380 in FIG. 3, 4, or 5) to describe the invention in detail.

First, FIG. 2 is explained that illustrates the case of no failure in the server. With a message M210, the user request transfer module 151 receives a request to process a file from the user program 140. To process a file means, for example, to create a file, delete a file, read a file, write a file, or the like. The user request transfer module 151 that has received the message M210 transfers this request to the client request provisional execution module 161a of the file system server with a message M220.

The client request provisional execution module 161a that has received the message M220 executes the request on the memory file system information 181a under a request R225. If the client request provisional execution module 161a needs data which is not in the memory file system information 181a, it notifies the disk file system module 163a of a read request with a message M222. In response to the message M222, the disk file system module 163a receives required data from the disk device 103a or other disk device under a request R226 and forwards this data to the client request provisional execution module 161a with a message M227.

The client request provisional execution module notifies the ACK processing module 152 in the file system client 141 of a processing result with a message M230. The ACK processing module 152 that has received the message M230 notifies the user request transfer module of the processing result with a message M240. Further, the user request transfer module 151 notifies the user program of the processing result with a message M250.

If the message M230 indicates error termination or if the file system has not been changed because of read processing, the processing is terminated.

If the message M230 indicates normal termination of processing of a request involving writing, the user request transfer module 151 registers the request in the request history information 171 under a request R215. The ACK processing module 152 further notifies the client request provisional execution module 161a of receipt of the message M230 with a message M260. The client request provisional execution module that has received the message M260 writes the same request as the request R225 to the disk device 103a or other disk device via the disk file system module 163a (M270 and R275). The disk file system module 163a notifies the client request provisional execution module of completion of the write to the disk with a message M280 and the client request provisional execution module returns a notice of write to the disk device 103a or other disk device to the ACK processing module 152 with a message M290. The ACK processing module 152 that has received the message M290 deletes the information on this processing from the request history information under a request R295. Through the above-described registering and deleting request history information, the request history information holds a list of requests in the course of writing to the disk device 103a or other disk device under the request R275. The presence of the request history information enables re-execution of a request for which completion of writing to the disk device 103a or other disk device has not been confirmed when a failure occurs in the server.

As an effect of the processing in accordance with the sequence of FIG. 2, it is guaranteed that the request R275 to write to the disk device 103 is never issued until the ACK processing module 152 of the client receives a result of processing the request or a message M230. If a failure occurs in the server before receiving the message M230, this feature guarantees that the ongoing processing does not involve any change to the disk device 103a or other disk device; accordingly, there is no possibility of double execution at re-execution.

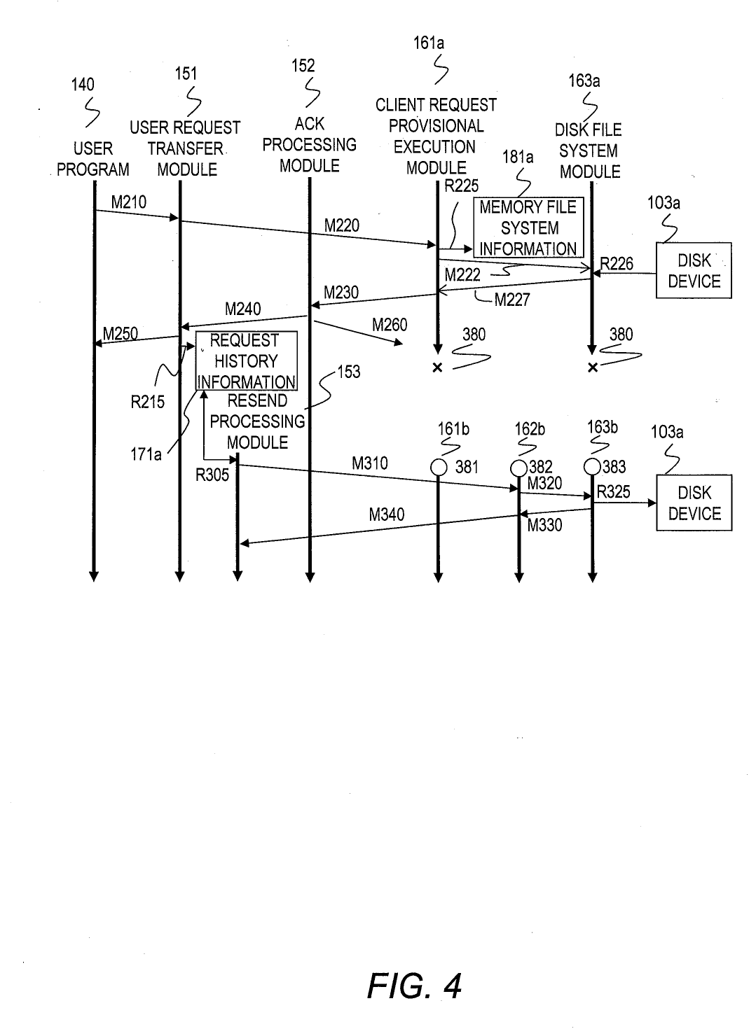

FIGS. 3 and 4 illustrate operations in the case where the ACK processing module 152 does not receive a response to the foregoing message M260 within a specific time period. The specific time period in this example is a threshold determined by the user of the file system and is specified in units of second, for example, 0.1 seconds or 1 second. In the drawings, the cross marks 380 indicate that the processing cannot be continued because of a server failure.

Between FIG. 3 and FIG. 4, times of occurrence of a failure in the server computer 102a are different; in FIG. 3, a failure occurs after the contents of the request have been reflected to the disk device 103a or other disk device under the request R275 and, in FIG. 4, a failure occurs before completion of execution of the request R275. In FIGS. 3, 4, and 5, the operations denoted by the same reference signs as those explained with FIG. 2 are the same operations; only the operations differing from those in FIG. 2 are described hereinafter.

First, FIG. 3 is explained. In FIG. 3, the user program 140, the user request processing module 151, the ACK processing module 152, and the resend processing module 153 are included in the client computer 101 as shown in FIG. 1. The client request provisional execution module 161a and the disk file system module 163a prior to the cross marks 380 are included in the computer 102a in FIG. 1.

The sequences starting from circles 381, 382, and 383 respectively represent the processing of the client request provisional execution module 161b, the failover processing module 162b, and the disk file system module 163b in the server computer 102b that takes over the processing from the server computer 102a.

When the ACK processing module 152 does not receive a response to the message M260 corresponding to the message M290 in FIG. 2 within a specific time period, it invokes the resend processing module 153. The resend processing module 153 retrieves the oldest request stored in the request history information, deletes it from the request history information 171 at the retrieving, and sends this request to the failover processing module 162b in the newly activated server computer 102b with a message M310. The failover processing module 162b makes a processing request to the disk file system module 163b in the substitute server 102b with a message M320 and the disk file system module 163b in the substitute server 102b writes to the disk device 103a or other disk device under a request R325 (as described above, requests remaining in the request history information are only for writing). The resend processing module 153 receives a result of the execution of the request M310 through messages M330 and M340.

Next, FIG. 4 is explained. The operations denoted by the same reference signs as those explained in FIG. 3 are the same operations. In FIG. 4, a failure occurs in the server computer 102a before the message M260 reaches the client request provisional execution module 161a; accordingly, the messages M270 and R275 shown in FIG. 3 are not sent out and the requested matter is not reflected to the disk device 103a or other disk device by the server computer 102a.

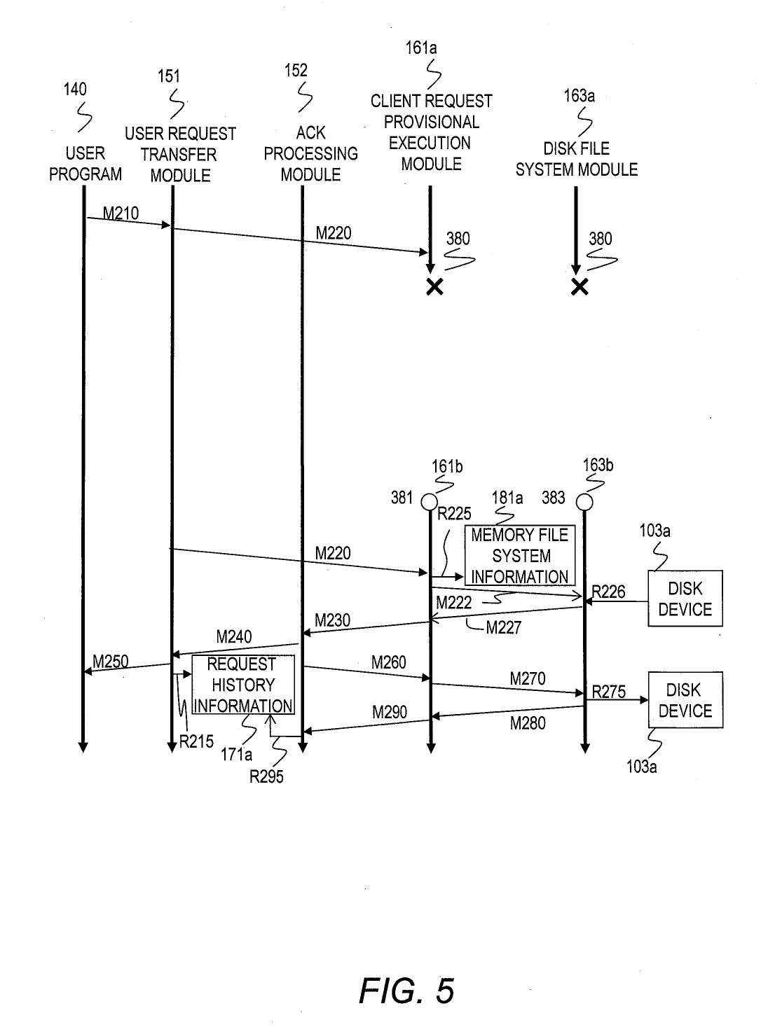

Next, with reference to FIG. 5, operations in the case where the user request transfer module 151 does not receive a result of the message M220 within a specific time period are explained. The operations denoted by the same reference signs as those explained in FIG. 3 or 4 are the same operations. In this case, the user request transfer module 151 resends the message M220 to the substitute server 102b with a message M220a. The operations thereafter are the same as the normal operations shown in FIG. 2.

Described above are outlines of overall processing in this embodiment. Hereinafter, operations in each module to perform such processing and a method of storing data in the memory are described in detail.

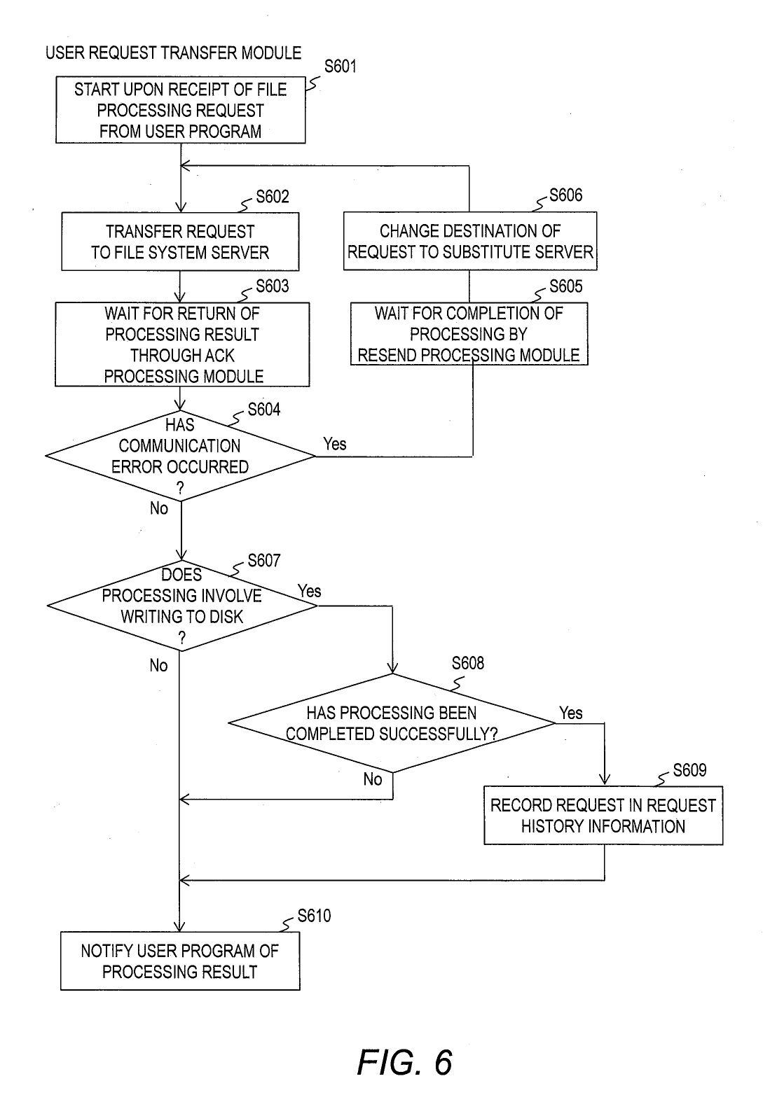

FIG. 6 is a flowchart illustrating processing of the user request transfer module 151.

The user request transfer module 151 starts running in response to receipt of a file processing request from the user program 140 (S601). Upon start, at Step S602, the user request transfer module 151 forwards the file processing request to the client request provisional execution module 161a of the file system server in the server computer 102a. At Step S5603, the user request transfer module 151 waits for return of a result of processing in the client request provisional execution module 161a or the disk file system module 163a of the file system server in the server computer 102a through the ACK processing module 152. Step S604 is to wait for a message from the server; unless the user request transfer module 151 receives a message from the server within a specific time period, it determines that a communication error has occurred. Then, after waiting for the completion of later-described processing of the resend processing module 153 at Step S605, the user request transfer module 151 changes the destination of the request to the substitute server 102b at Step S606 and resends the request to the substitute server 102b at Step S602.

If, at Step S604, the user request transfer module 151 receives a message from the server within the specific time period, it determines that no communication error has occurred and proceeds to Step S607. Step S607 is to check a response from the server computer 102a or the server computer 102b if the route going through Step S606 is taken; the user request transfer module 151 checks whether the processing requested to the server at Step S602 involves writing to the disk device 103a or other disk device. If the result of checking is that the processing requested to the server at Step S602 does not involve writing to the disk device 103a or other disk device, the user request transfer module 151 returns, at Step S610, the result of the processing by the client request provisional execution module (161a or 161b) or the disk file system module (163a or 163b) of the file system server (142a or 142b) to the user program as a response to the request received at S601. If the result of the determination at Step S607 is that the processing requested to the server at Step S602 involves writing to the disk device 103a or other disk device, the user request transfer module 151 further determines, at Step S608, whether the result of processing the request by the client request provisional execution module or the disk file system module of the file system server (142a or 142b) is successful. If the result of determination is that the processing was failed, the user request transfer module 151 performs Step S610, which has already been described. If the result of the determination is that the processing has been successfully completed, the user request transfer module 151 stores the request to the request history information at Step 609 and performs Step S610.

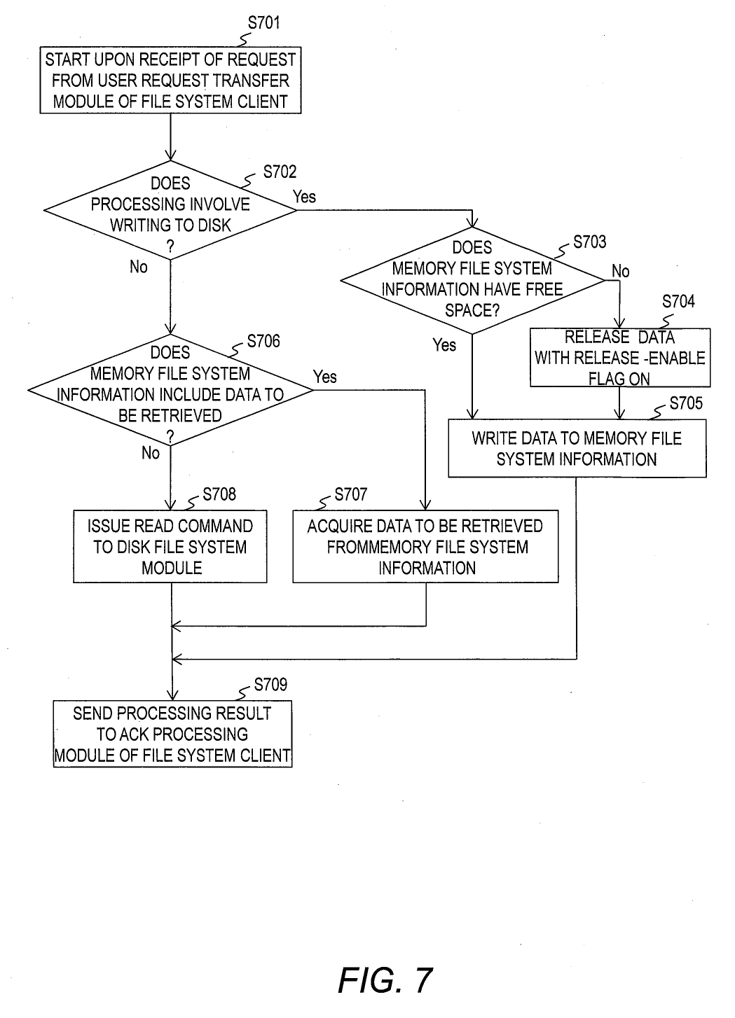

Next, with reference to FIG. 7, processing of the client request provisional execution module (161a or 161b) is described. FIG. 7 explains the client request provisional execution module 161a by way of example.

The client request provisional execution module 161a starts running in response to receipt of a request from the above-described user request transfer module 151 (Step S701). Upon start, the client request provisional execution module 161a determines whether the received request is for processing involving writing to the disk device 103a or other disk device (S702).

If the determination at Step S702 is that the received request is for processing involving writing to the disk device 103a or other disk device, the client request provisional execution module 161a first determines, at Step S703, whether the memory file system information 181a has free space. If the determination at Step S703 is that the memory file system information 181a has no free space, the client request provisional execution module 161a deletes data with a release-enable flag ON to release the storage area at Step S704. Thereafter, the client request provisional execution module 161a performs the requested writing to the memory file system information 181a at Step S705. If the determination at Step S703 is that the memory file system information 181a has free space, the client request provisional execution module 161a skips S704 to perform the requested writing to the memory file system information 181a at Step S705.

If the determination at Step S702 is that the received request is not for processing involving writing to the disk device 103a or other disk device, the client request provisional execution module checks whether the designated data exists in the memory file system information 181a at Step S706. If, at Step S706, the designated data exists in the memory file system information 181a, the client request provisional execution module 161a retrieves the data from the memory file system information 181a at Step S707. If the designated data does not exist in the memory file system information 181a at Step S706, the client request provisional execution module 161a issues a read command to the disk file system module 163a at Step S708 and acquires the requested data. Finally, at Step S709, the client request provisional execution module 161a sends a notification indicating whether an error has occurred in the foregoing operations on the memory file system to terminate the processing.

The processing of the client request provisional execution module (161a or 161b) is featured by performing processing involving a change of the disk device 103a or other disk device on the memory file system information before actually requesting the disk device 103a or other disk device to perform the processing. The existence of the client request provisional execution module has an effect that whether writing to the disk device 103a or other disk device by a request from the user request transfer module 151 in the file system client has been performed can be determined without actually manipulating the disk device 103a or other disk device.

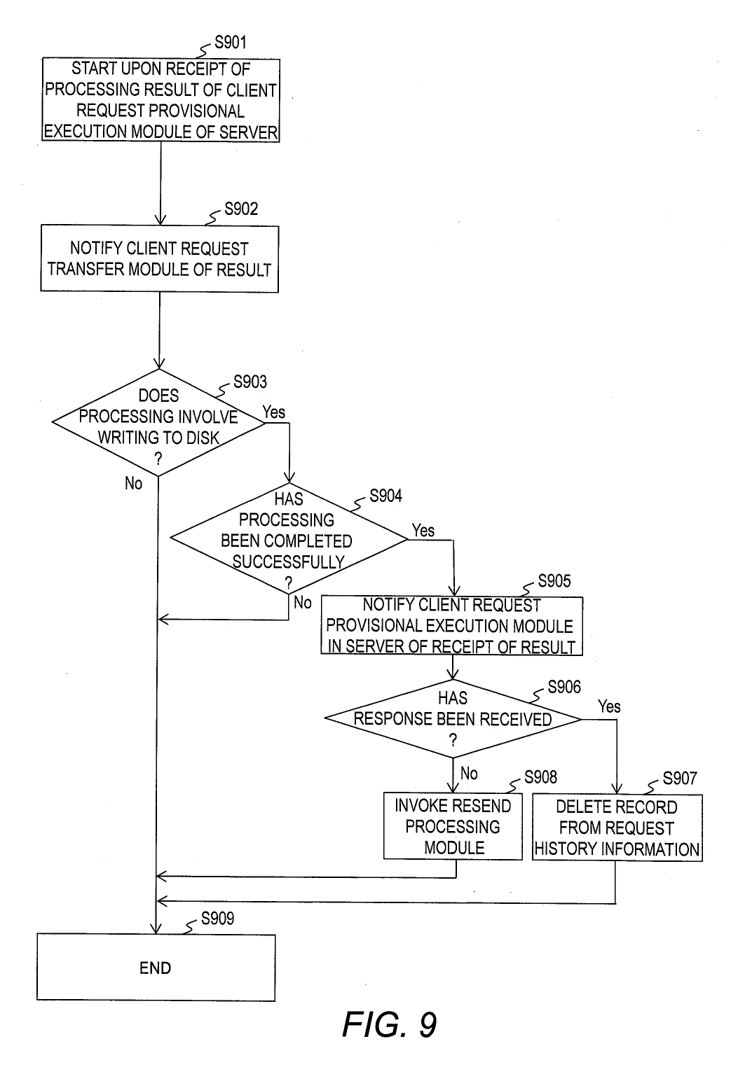

The processing on the memory file system information (181a or 181b) is featured by that information in the memory file system information (181 a or 181b) will not be deleted without going through later-described Step S905 in FIG. 9 (that is to say, without receiving a command from the ACK processing module 152 in the file system client). This is a difference from existing technology like disk cache, which freely discards the contents when the free space is exhausted.

Next, with reference to FIG. 9, processing of the ACK processing module 152 is described. The ACK processing module 152 starts running in response to receipt of a processing result M230 of the client request provisional execution module (161a or 161b) (Step S901). The activated ACK processing module 152 notifies the user request transfer module 151 of the received result with the message M240 in FIG. 2, 3, or other figure at Step S902. Thereafter, the ACK processing module 152 determines whether the command is for processing involving writing to the disk device 103a or other disk device at Step S903. If the determination at Step S903 is that the command is not for processing involving writing to the disk device 103a or other disk device, the ACK processing module 152 terminates the processing (S909).

If the determination at Step S903 is that the command is for processing involving writing to the disk device 103a or other disk device, the ACK processing module 152 determines whether a notification of successful processing has been received from the client request provisional execution module (161a or 161b) at Step S904. If the determination at Step S904 is that the processing is not successfully completed, the ACK processing module 152 terminates the processing (S909). If the determination at Step S904 is that the processing has been successfully completed, the ACK processing module 152 sends a message (M260) acknowledging a message M230 in FIG. 3, 4, or other figure to the client request provisional execution module (161a or 161b) at Step S905 and determines whether the ACK processing module 152 has received a response (M290) to this message at Step S906.

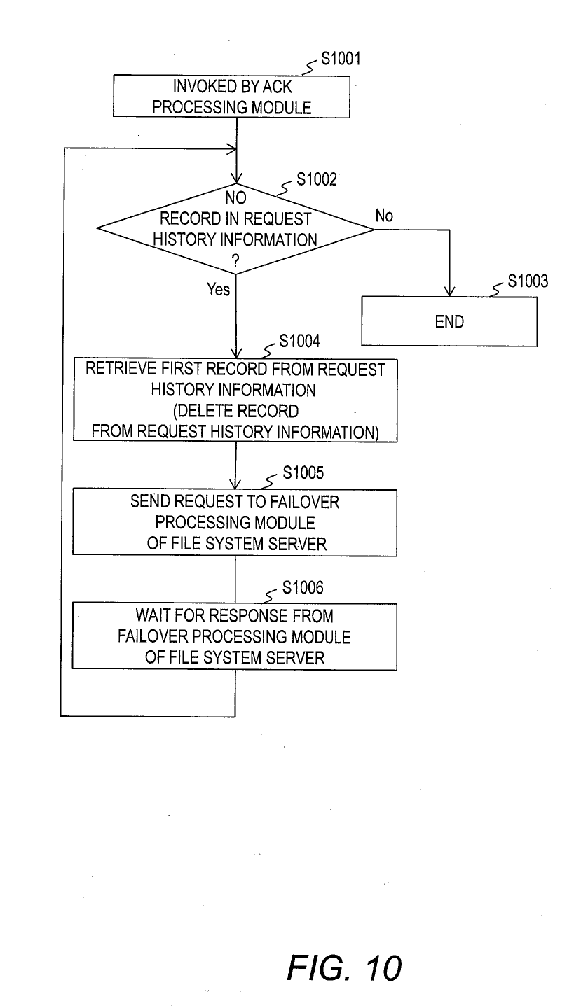

If the determination at Step S906 is that a response to the message has been received, the ACK processing module 152 deletes the request from the request history information at Step S907 and terminates the processing at Step S909. If the determination at Step S906 is that no response has been received, the ACK processing module 152 invokes the resend processing module 153 at Step S908 and terminates the processing at Step S909. The Step S907 to delete the request history information prevents unnecessary re-execution by the later-described resend processing module 153 in FIG. 10.

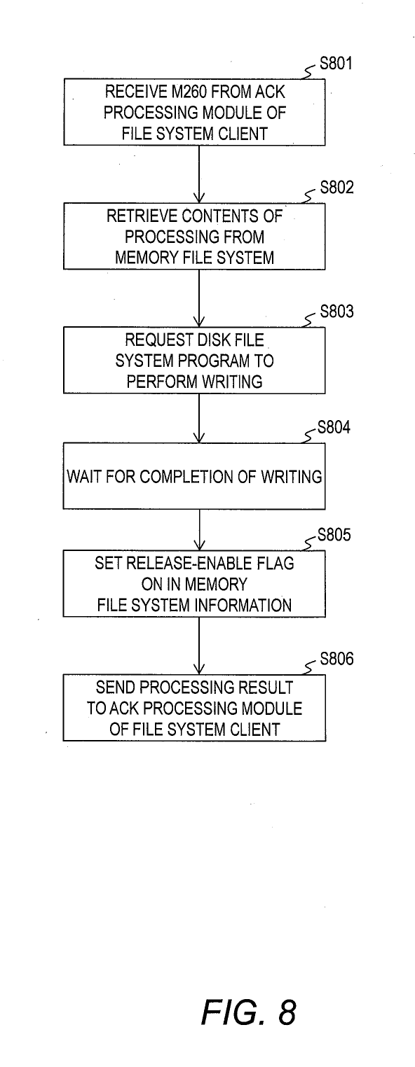

Next, with reference to FIG. 8, operations of the client request provisional execution module (161a or 161b) upon receipt of a message M260 sent by the operation of the ACK processing module 152 at Step S905 in FIG. 9 are described. The client request provisional execution module (161a or 161b) that has received the message M260 in FIG. 3, 4, or other figures at Step S801 retrieves data written under the request R225 explained in FIG. 2 from the memory file system information 181a at Step S802. Subsequently, the client request provisional execution module (161a or 161b) requests the disk file system module 163a to write the data (M270) at Step S803 and waits for a response indicating the completion of the writing (M280) at Step S804. After receipt of the response, the client request provisional execution module (161a or 161b) sets the release-enable flag ON to indicate that the data in the memory file system information may be deleted and finally at Step S806, notifies the ACK processing module 152 in the file system client of the completion of processing (M290).

Next, with reference to FIG. 10, operations of the resend processing module 153 are described. As described above at Step S908 in FIG. 9, the resend processing module 153 starts running upon receipt of a command to start from the ACK processing module 152. The resend processing module 153 determines whether the request history information 171 has no record at Step S1002 and if it has no record, it terminates the processing at Step S1003. If it includes some record, the resend processing module 153 retrieves the first record in the history, which is the oldest request, from the request history information at Step S1004 and then deletes it from the history information. The resend processing module 153 sends this request to the failover processing module 162b (M310) at Step S1005. Next, the resend processing module 153 waits for receiving a response message M340 from the failover processing module 162b at Step S1006. Finally, the resend processing module 153 returns to the determination at Step S1002.

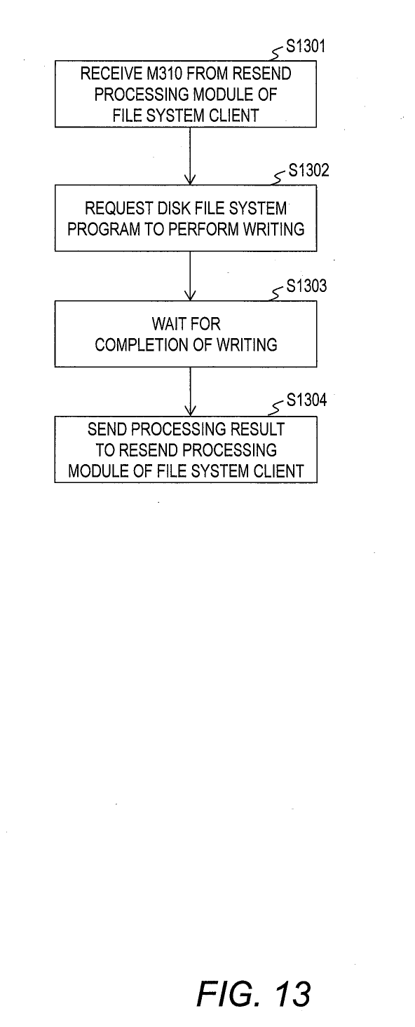

Next, with reference to FIG. 13, operations of the failover processing module 162b are described.

The failover processing module 162b receives a message M310 explained in FIG. 3 or 4 from the resend processing module 153 at Step S1301 and sends the processing request included in the message M310 to the disk file system module 163b (M320) at Step S1302. Then, the failover processing module 162b waits for a notice of completion of writing (M330) from the disk file system module 163b at Step S1303 and upon receipt of the notice of completion, the failover processing module 162b notifies the resend processing module 153 of the result of the file write by the disk file system module 163b (M340).

The failover processing module 162b intermediates between the resend processing module 153 and the disk file system module 163b. The existence of the failover processing module 162b eliminates the necessity for the disk file system module 163b to have a function equivalent to the resend processing module 153, so that the file system included in an existing operating system can be used without change.

Described above is Embodiment 1 of the invention. This embodiment guarantees that, as explained with reference to FIG. 2, the message M220 representing a request from the client will not be executed on the disk device 103a or other disk device unless the client computer receives the message M230. Accordingly, when a substitute server is activated to re-execute the request with the message M310 in FIG. 4, there is no possibility of double execution.

In the sequence in FIG. 3, however, the request to the disk device 103a or other disk device is issued twice with the request R275 and R325; accordingly, the second request causes double execution. Consequently, such an operation that does not allow second execution, like file creation, will be failed. However, since the client computer has acknowledged the successful completion of the processing with the message M230 in the sequence of FIG. 3, it can be determined that a failure in the second execution is not a kind to be reported to the user program and is caused by the second execution. Accordingly, this error can be ignored to guarantee that information indicating whether an error has occurred reported to the user program with the message M250 is consistent with the state of the disk device 103a or other disk device.

As set forth above, the server computer is controlled so as not to perform writing to the disk device 103a or other disk device with respect to a request for which processing result, whether successful or failed, is unknown. This control provides a failover function without adding special processing such as writing transaction numbers to the disk device 103a or other disk device.

### Embodiment 2

Hereinafter, Embodiment 2 is explained. Embodiment 2 is the same as Embodiment 1 in the basic configurations and operations of the client computer and the server computers but is to provide these configurations and operations in a parallel file system. Therefore, This embodiment explains only the configurations and operations different from Embodiment 1.

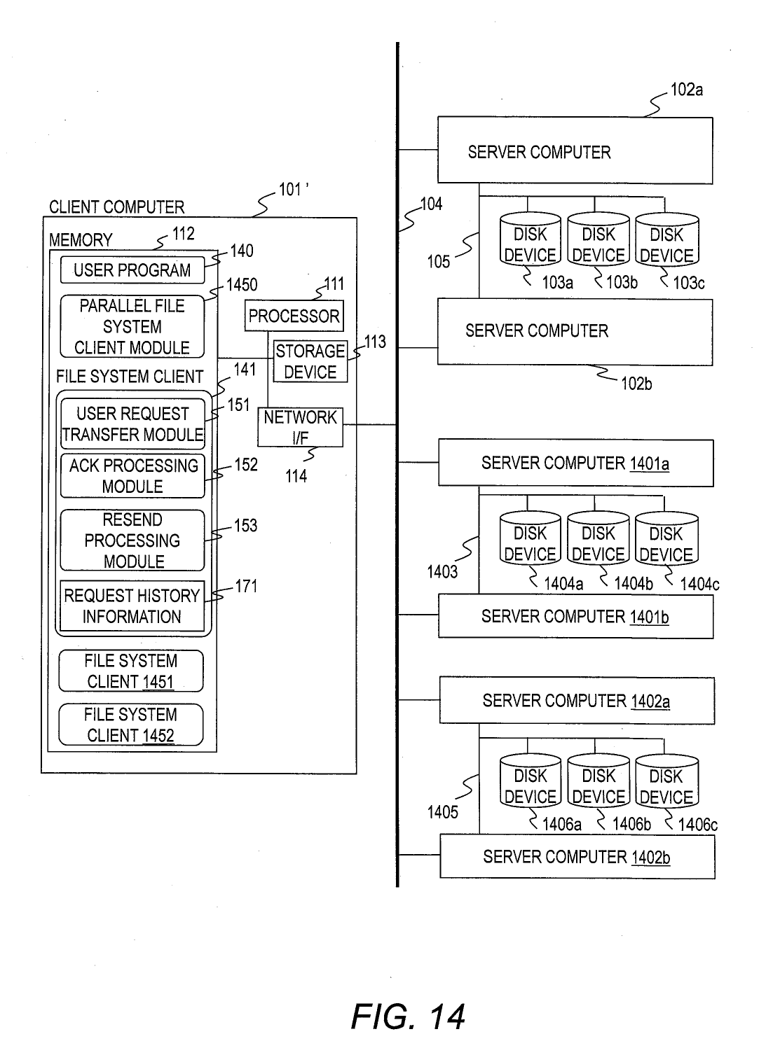

FIG. 14 is a diagram illustrating an example of a system configuration in the case where the invention is applied to a parallel file system. The parallel file system provides a single file system using a plurality of server computers. There are two approaches to provide such a system: one is that a server computer called a meta data server manages directory structures and file properties and the other servers store data in the files; and the other is that all servers equally share the roles to store a part of the directories and files.

In Embodiment 2 of the invention, the server computers to be the parallel file servers are each composed of a main server and an auxiliary server as shown in FIG. 14; for example, the computers 102a and 102b are the main and auxiliary server computers for managing meta data; computers 1401a and 1402a are main servers for managing data; and computers 1401a and 1402b are auxiliary servers for managing data. The components denoted by the same numbers as those in FIG. 1 have the same functions as those in Embodiment 1; accordingly, they are not explained here. A parallel file system client module 1450 in the client computer 101′ controls the client computer 101′ to operate in a parallel file system. The file system clients 1451 and 1452 each include a user request transfer module 151, an ACK processing module 152, a resend processing module 153, and request history information 171, like the file system client 141. In this example, the file system client 141 regards the server computers 102a and 102b as its servers. The file system client 1451 regards the server computers 1401a and 1401b as its servers. The file system client 1452 regards the server computers 1402a and 1402b as its servers.

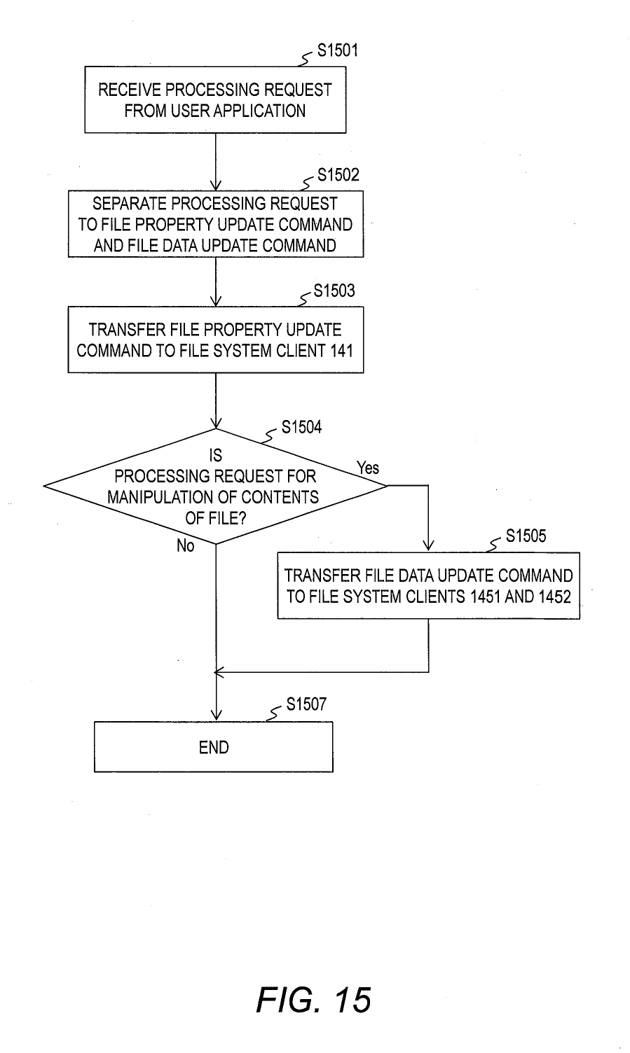

FIG. 15 illustrates operations of the parallel file system client module 1450. First at Step S1501, the parallel file system client module receives a request for file manipulation from the user application. Next at Step S1502, the parallel file system client module separates the request into a request for manipulation of file property and a request for manipulation of file data. Then, the parallel file system client module requests the file system client 141 to manipulate the file properties at Step S1503.

Next, at determination Step S1504, the parallel file system client module determines whether the contents of the processing involve an access to the contents of the file. If the determination at Step S1504 is that the contents of the processing involve an access to the contents of the file, the parallel file system client module requests the file system client 1451 or 1452 to access the file at Step S1505. Since the operations of the file system clients 141, 1451, and 1452 are the same as those in the foregoing Embodiment 1, explanation is omitted here. If the determination at Step S1504 is that the processing does not involve an access to the contents of the file or when Step S1505 has been completed, the parallel file system client module terminates the processing at Step S1507.

As described above, according to Embodiment 2 which applies the invention to a parallel file system, if a failure occurs in one of the servers 102a, 1401a, and 1402a constituting a parallel file system, the substitute server 102b, 1401b, or 1402b can take over the processing. This configuration can eliminate an error causing an inconsistency, for example, a state where the processing is completed successfully up to S1503 in FIG. 15 but failed at S1505. As a result, the invention enhances the soundness of the whole parallel file system.

The invention is not limited to the above-described embodiments but includes various modifications. The above-described embodiments are explained in details for better understanding of the invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card. The drawings shows control lines and information lines as considered necessary for explanation but do not show all control lines or information lines in the products. It can be considered that almost of all components are actually interconnected.

### REFERENCE SIGNS LIST

101 CLIENT COMPUTER
102a MAIN SERVER COMPUTER
102b AUXILIARY SERVER COMPUTER
103a-103c DISK DEVICES
141 FILE SYSTEM CLIENT
142a FILE SYSTEM SERVER
151 USER REQUEST TRANSFER MODULE
152 ACK PROCESSING MODULE
153 RESEND PROCESSING MODULE
161a CLIENT REQUEST PROVISIONAL EXECUTION MODULE
162a FAILOVER PROCESSING MODULE
163a DISK FILE SYSTEM MODULE
171 REQUEST HISTORY INFORMATION
181a MEMORY FILE SYSTEM INFORMATION

1. A computer system comprising:
at least one server computer;
a client computer for managing the at least one server computer; and
a storage device connectable from the at least one server computer,
wherein, upon receipt of an information processing request of a request signal for writing to the storage device from the client computer, the at least one server computer performs provisional writing, which is writing related to the information processing request, to a first storage part included in the at least one server computer and sends a first notification signal indicating completion of the provisional writing to the client computer,
wherein, upon receipt of the first notification signal, the client computer sends a second notification signal indicating that the client computer has received the first notification signal to the at least one server computer, and
wherein, upon receipt of the second notification signal, the at least one server computer retrieves contents of the provisional writing from the first storage part and writes the contents of the provisional writing to the storage device.

2. The computer system according to claim 1, wherein, upon receipt of the first notification signal, the client computer holds the contents of the information processing request in a second storage part included in client computer.

3. The computer system according to claim 2,
wherein, upon completion of the writing the contents of the provisional writing to the storage device, the at least one server computer sends a third notification signal indicating that the writing to the storage device has been completed to the client computer, and
wherein, upon receipt of the third notification signal, the management computer deletes the contents of the information processing request held in the second storage part.

4. The computer system according to claim 1, wherein the at least one server computer uses information retrieved from the storage device in performing the provisional writing.

5. The computer system according to claim 1,
wherein the computer system manages a first server computer and a second server computer of a substitute server for the first server computer as the at least one server computer,
wherein, in a case where the first server computer receives an information processing request from the client computer, the client computer holds contents of the information processing request in a second storage part included in the client computer upon receipt of the first notification signal from the first server computer, and
wherein, when a failure occurs in the first server computer, the second server computer takes over processing related to the information processing request based on the contents of the information processing request held in the second storage part.

6. A computer system control method in a computer system including at least one server computer, a client computer for managing the at least one server computer, and a storage device connectable from the at least one server computer, the computer system control method comprising:
performing, by the at least one server computer which has received an information processing request of a request signal for writing to the storage device from the client computer, provisional writing, which is writing related to the information processing request, to a first storage part included in the at least one server computer and sending a first notification signal indicating that the provisional writing has been completed to the client computer;
sending, by the client computer which has received the first notification signal, a second notification signal indicating that the first client computer has received the first notification signal to the at least one server computer; and
retrieving, by the at least one server computer which has received the second notification signal, contents of the provisional writing from the first storage part and writing the contents of the provisional writing to the storage device.

7. The computer system control method according to claim 6, further comprising:
holding, by the client computer which has received the first notification signal, the contents of the information processing request in a second storage part included in the client computer.

8. The computer system control method according to claim 7, further comprising:
sending, by the at least one server computer which has completed the writing the contents of the provisional writing to the storage device, a third notification signal indicating that the writing to the storage device has been completed; and
deleting, by the client computer which has received the third notification signal, the contents of the information processing request held in the second storage part.

9. The computer system control method according to claim 6, wherein the at least one server computer uses information retrieved from the storage device in performing the provisional writing.

10. The computer system control method according to claim 6,
wherein the computer system manages a first server computer and a second server computer of a substitute server for the first server computer for the at least one server computer,
wherein, in a case where the first server computer receives an information processing request from the client computer, the computer system control method further comprises:
holding, by the management computer which has received the first notification signal from the first server computer, contents of the information processing request in a second storage part included in the management computer; and
taking over, by the second server, processing related to the information processing request based on the contents of the information processing request held in the second storage part in a case where a failure occurs in the first server computer.

11. A server computer connectable to a client computer and a storage device, the server computer comprising:
a transceiver part for transmitting signals to and receiving signals from the client computer;
an information storage part for storing information;
a storage device access part for writing information to the storage device and retrieving information from the storage device; and
a processing request provisional execution part for performing provisional writing, which is writing related to an information processing request, to the information storage part upon receipt of the information processing request of a request signal for writing to the storage device from the client computer,
wherein the transceiver part sends a first notification signal indicating completion of the provisional writing to the client computer,
wherein the transceiver part receives a second notification signal indicating that the client has received the first notification signal, and
wherein the storage device access part retrieves contents of the provisional writing from the information storage part and writes the contents of the provisional writing to the storage device upon receipt of the second notification signal.

12. The server computer according to claim 11, wherein the transceiver part sends a third notification signal indicating that the writing to the storage device has been completed upon completion of the writing the contents of the provisional writing to the storage device.

13. The server computer according to claim 11, wherein the storage device access part uses information retrieved from the storage device in performing the provisional writing.
